(19) United States
(12) Patent Application Publication
(10) Pub. No.: US 2014/0115112 A1
(43) Pub. Date: Apr. 24, 2014

(54) SERVER SYSTEM AND MESSAGE PROCESSING METHOD THEREOF

(71) Applicants: INVENTEC (PUDONG) TECHNOLOGY CORPORATION, Shanghai (CN); INVENTEC CORPORATION, Taipei City (TW)

(72) Inventors: Hao-Hao WANG, SHANGHAI (CN); Min CHU, SHANGHAI (CN)

(73) Assignees: INVENTEC CORPORATION, TAIPEI CITY (TW); INVENTEC (PUDONG) TECHNOLOGY CORPORATION, Shanghai (CN)

(21) Appl. No.: 13/792,232

(22) Filed: Mar. 11, 2013

(30) Foreign Application Priority Data
Oct. 24, 2012 (CN) 201210411175.2

(51) Int. Cl. H04L 12/24

(52) U.S. Cl. CPC H04L 41/24
USPC 709/219

(57) ABSTRACT

A server system and a message processing method thereof are provided. The server system mentioned above includes a baseboard management controller (BMC) and a mainboard system. Output messages are received from the mainboard system by the BMC and are stored into a buffer in the BMC. When a command is received from a remote device, the corresponding output messages are acquired from the buffer according to the received command, and are transmitted to the remote device.

### RELATED APPLICATIONS

This application claims priority to Chinese Application Serial Number 20121041175.2, filed Oct. 24, 2012, which is herein incorporated by reference.

### BACKGROUND

1. Field of Invention

The present invention relates to a server system, and more particular, relates to a server system processing messages by a baseboard management controller (BMC) and a message processing method thereof.

2. Description of Related Art

Currently, servers are widely used by various enterprises. Apart from being applied in conjunction with internet and the telecommunications industry, the servers are further developed deeply into the life of general people. For example, financial and economical businesses, online banking and the usage of network credit cards all should be based on the powerful calculation capabilities of servers.

In order to meet the needs of the market, some manufacturers in the industry provide an intelligent platform management interface (IPMI). IPMI is a new-generation general-purpose interface standard enabling the hardware management to be intelligent, which can be used by users to monitor the physical health characteristics of a server, such as temperature, voltage, fan working state, power supply and chassis intrusion, so as to provide information for system management and recovery, and asserts management.

A baseboard management controller (BMC) is the core controller of the IPMI management platform. System management software can manage various managed apparatuses by BMC communication. The BMC can be used to provide an interface between management software for controlling the system and platform management hardware, and functions such as automatic monitoring, event recording and control recovery, and can be used as a gateway between the interfaces of system management software, intelligent platform management bus (IPMB) and intelligent chassis management bus (ICMB), The BMC has a self-contained power and monitors the system health condition automatically. The BMC can take actions such as event recording, warning, auto power-off and reboot immediately once any abnormality of the controlled units is discovered.

### SUMMARY

A server system and a message processing method thereof are provided, and a baseboard management controller (BMC) automatically collects the output messages outputted by a mainboard system when a networking function is turned off.

A message processing method for a server system is provided, which is suitable for a BMC. The server system includes a BMC and a mainboard system having a serial port connected with the BMC. The preliminary step includes: creating a buffer in the memory of the BMC. The executing step includes: receiving multiple output messages from the serial port of the mainboard system by the BMC; performing a first mode by the BMC to store the output messages mentioned above into the buffer; performing a second mode by the BMC according to a switching command to stop storing the output messages mentioned above into the buffer and enable a remote device to access the serial port mentioned above through a network to exchange data with the mainboard system; receiving a command from the remote device through the network and acquiring the corresponding output message from the buffer according to the command mentioned above; and transmitting the corresponding output message to the remote device.

In an embodiment of the present invention, after the above-mentioned step of receiving the output messages from the serial port of the mainboard system, the receiving time when the output messages are received from the mainboard system can be recorded into the buffer

In an embodiment of the present invention, the command mentioned above includes a specified time. In the step of acquiring the corresponding output message from the buffer according to the command mentioned above, the output message for which the receiving time matches with the specified time can be acquired from the buffer.

In an embodiment of the present invention, after the step of acquiring the corresponding output message from the buffer according to the command mentioned above, an acquiring time when the output messages are acquired can also be recorded and the output messages marked with the acquiring time can be deleted when a message deleting command is received.

In an embodiment of the present invention, in the message processing method mentioned above, when the buffer is full, the output message with the earliest receiving time is transmitted to a storage unit of the BMC and the output message with the earliest receiving time is replaced by a newly-received output message; and the output message mentioned above can be read by the remote device through the network from the storage unit.

In an embodiment of the present invention, in the message processing method mentioned above, when a turn-off command is received from the remote device, the collection of the output messages of the mainboard system is stopped and the content of the buffer is reset.

In an embodiment of the present invention, the switching command mentioned above is sent from the remote device (SOL).

A server system is provided, including a mainboard system and a BMC. The mainboard system has a serial port. The BMC has a buffer and a network interface. The BMC is coupled to the serial port to store the output messages received by the serial port into the buffer. Moreover, the BMC is connected to a remote device through the network interface, so as to stop storing the output messages into the buffer according to a switching command to enable the remote device to access the serial port through the network interface to exchange data with the mainboard system; and when a command is received from the remote device, the corresponding output message can be acquired from the buffer according to the command mentioned above and be transmitted to the remote device.

In an embodiment of the present invention, the BMC mentioned above can record the receiving time when the output messages are received from the mainboard system into the buffer, and when a command including a specified time is received, the BMC can output the output messages of which the receiving time matches with the specified time to the remote device.

In an embodiment of the present invention, the BMC mentioned above also records an acquiring time when the output messages are acquired and deletes the output messages marked with the acquiring time when a message deleting command is received.

In an embodiment of the present invention, when a turn-off command is received by the BMC from the remote device, the collection of the output messages of the mainboard system is stopped and the content of the buffer is reset.

Based on the description above, in the present invention, a buffer is provided inside the BMC to store the output messages outputted by the serial port of the mainboard system. When being connected to the server system, a remote user can acquire the contents of the buffer at any time to further get the output messages (e.g., screen output) before the connection. Therefore, when a problem occurs in the mainboard system, the user can use the remote device to connect to the server system through the network leisurely, to get the related output messages by the method mentioned above.

In order to make the foregoing features and advantages of the present invention more apparent, the embodiments are described in details hereafter with reference to the accompanying drawings.

### BRIEF DESCRIPTION OF THE DRAWINGS

FIG. 1 is a block diagram of a server system according to an embodiment of the present invention;

FIG. 2 is a flowchart of a message processing method for a server system according to an embodiment of the present invention;

FIG. 3 is a schematic diagram of the connection relations between a remote device and a server system according to an embodiment of the present invention: and

FIG. 4 is a block diagram of a processing module of a baseboard management controller according to an embodiment of the present invention.

### DETAILED DESCRIPTION

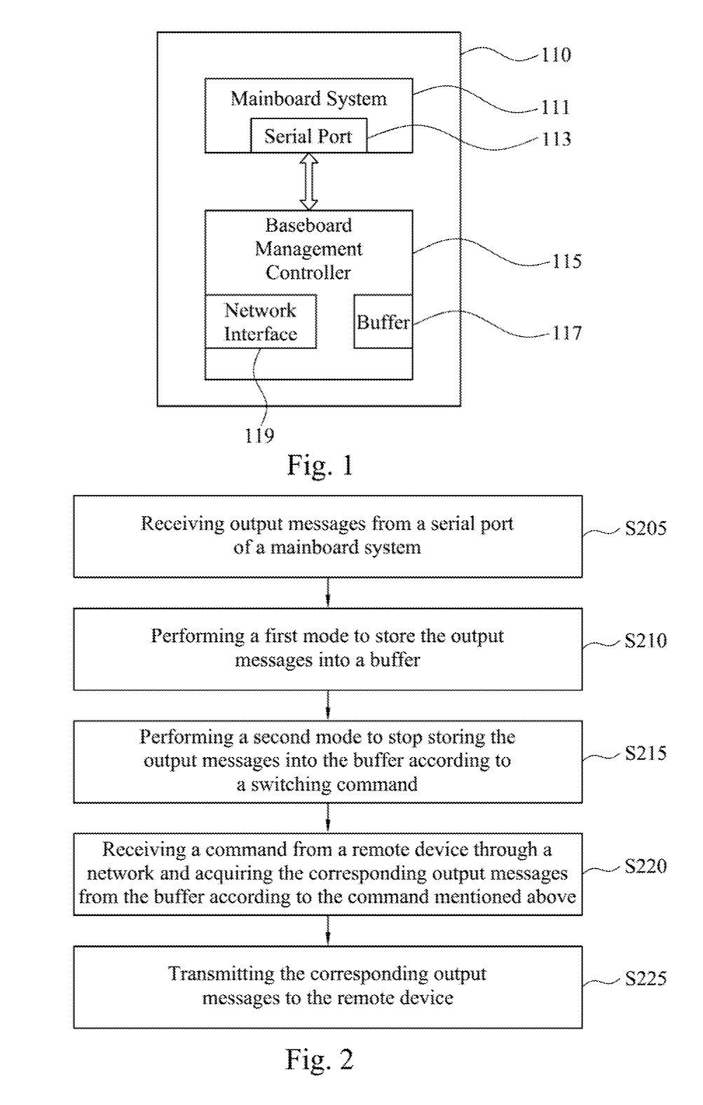

FIG. 1 is a block diagram of a server system according to an embodiment of the present invention. As shown in FIG. 1, a server system 110 includes a mainboard system 111 and a baseboard management controller (BMC) 115. The mainboard system 111 has a serial port 113, and the BMC 115 has a buffer 117 and a network interface 119. The BMC 115 is coupled to the serial port 113 of the mainboard system 111 and is connected to a remote device 310 through the network interface 119. The BMC 115 can receive output messages from the serial port 113 of the mainboard system 111. The output messages are important messages such as kernel panic messages.

For example, when the mainboard system 111 outputs a kernel panic message, the kernel panic message is displayed on a screen and users can see the message by kernel based virtual machine (KVM) or KVM over IP (iKVM). Since the output messages of the mainboard system 111 are instant, in this embodiment, a buffer 117 is provided in the BMC 115 to collect the output messages. Therefore, the BMC 115 can store the output messages in the buffer 117 when receiving the output messages from the mainboard system 111.

For example, the buffer 117 is usually provided in a storage device such as a random access memory (RAM) or a dynamic random access memory (DRAM). For instance, with respect to writing syntax of programming language, a global array with a size 2 K or more can be defined. Alternatively, a malloc function can be used to establish a stack space. Also, a variable is defined to record whether the data of the global array defined above begins to loop, namely, whether the data begins to overwrite the oldest data. Moreover, a position index of the current array and an array top index can also be defined to speed up the execution by index operation. Also, a variable can be defined to record a receiving time when the last character is received (option function).

The steps of the message processing method are described in detail hereafter with reference to the server system 110 hereinafter. FIG. 2 is a flowchart of a message processing method of a server system according to an embodiment of the present invention. As shown in FIGS. 1 and 2, in step S205, the BMC 115 receives output messages from the serial port 113 of the mainboard system 111. The output messages mentioned above are for example screen messages or other messages of the mainboard system 111.

Then, in step S210, the BMC 115 performs a first mode to store the output messages into the buffer 117. The BMC 115 can receive the output messages from the mainboard system 111 at any time via the serial port 113 and can store the received output messages temporarily in the buffer 117.

Then, in step S215, the BMC 115 performs a second mode according to a switching command to stop storing the output messages into the buffer. A remote device accesses the serial port 113 through a network to exchange data with the mainboard system 111. The switching command for example is sent from the remote device( ) to enable the BMC 115 to perform the second mode.

For example, the mainboard system 111 has a serial over local area network (SOL) function. The BMC 115 can also acquire the output messages of the mainboard system 111 at any time and store the output messages into the buffer 117, even when the SOL function is not enabled. However, when the SOL function is enabled by the remote device, the remote device can access the serial port 113 of the mainboard system 111 through the network. Moreover, the remote device transmits the switching command to enable the BMC to perform the second mode, namely, stopping storing the output messages into the buffer 117.

Then, in step S220, the BMC 115 receives a command from the remote device through the network and acquires the corresponding output message from the buffer 117 according to the received command. For example, the BMC 115 may receive a command transmitted by the remote device and acquire the corresponding output messages from the buffer 117 according to the command. The command mentioned above may be, but not limited to a command of an original equipment manufacturer (OEM).

Then, in the step S225, the BMC 115 transmits the corresponding output messages to the remote device through the network interface 119. For example, the BMC 115 is connected to a network through the network interface 119, and then the remote device can send a command to the BMC 115 through the network. After acquiring the corresponding output message, the BMC 115 further transmits the output message to the remote device sending the command mentioned above through the network interface 119.

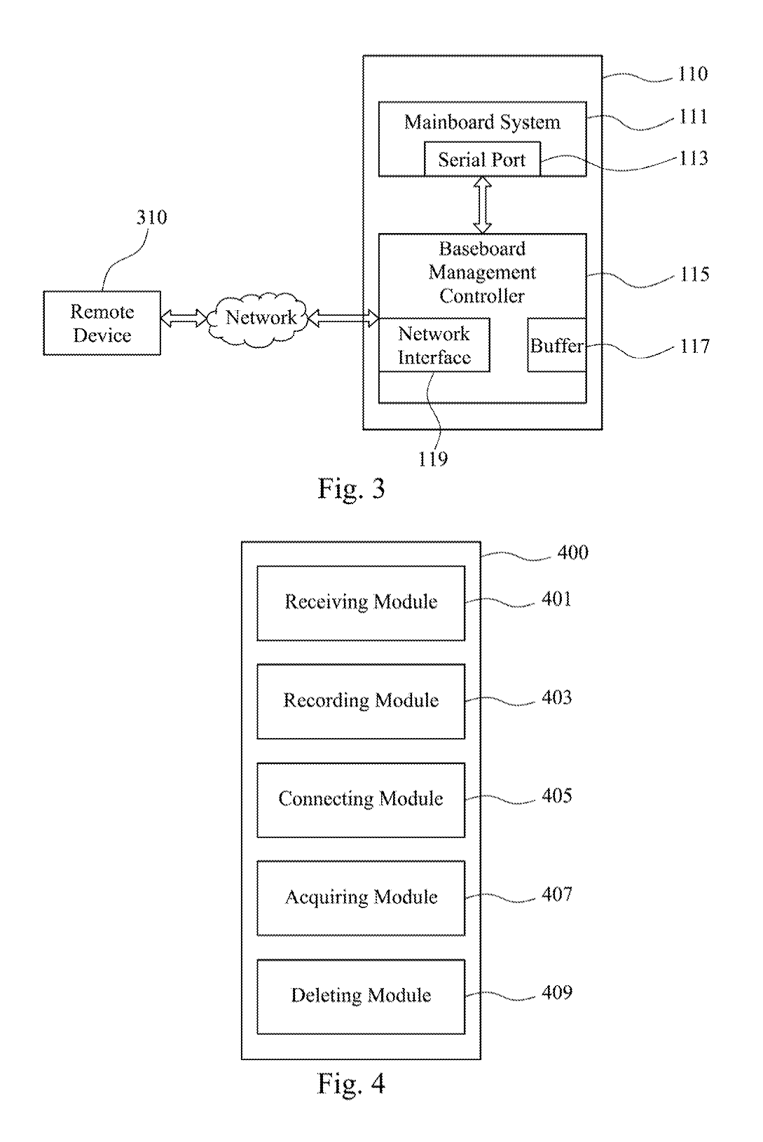

In order to illustrate more clearly, another embodiment is described hereinafter to illustrate the connection relations between a remote device and a server system. FIG. 3 is a schematic diagram of the connection relations between a remote device and a server system according to an embodiment of the present invention. This embodiment takes the server system 110 mentioned above as an example.

The BMC 115 is connected to the network through the network interface 119, so that the remote device 310 can communicate with the BMC 115 through the network. When the remote device 310 communicates with the BMC 115 through the network, the output messages can be acquired from the buffer 117. For example, the remote device 310 can transmit the switching command or any other command to the BMC 115 through the network, and the BMC 115 can perform corresponding actions according to the received switching command or other commands and pass back a response or data to the remote device 310.

In this embodiment, the BMC 115 can acquire the output messages of the mainboard system 111 at any time and store the output messages in the buffer 117, before the SOL function is enabled. Afterwards, when a user of the remote device 310 enables the SOL function, the user can use the remote device 310 to transmit a command to the BMC 115.

For example, the remote device 310 can communicate with the mainboard system 111 in the server system 110 by the SOL function. For example, power-off, power-on and any other settings of the mainboard system 111 can be performed by the remote device 310 by the SOL function. The remote device 310 can further transmit the command to the BMC 115.

In addition, the BMC 115 can further determine whether to store the received output messages into the buffer 117 according to whether the SOL function is enabled. For example, when the SOL function is enabled, the BMC 115 stops collecting the output messages from the serial port 113 temporarily (i.e., the second mode). When the SOL function is turned off, the BMC 115 begins to collect the output messages from the serial port 113 (i.e., the first mode) again and store the output messages from the serial port 113 into the buffer 117.

Moreover, the BMC 115 can also record a receiving time when the output messages are received from the mainboard system 111 into the buffer 117. In other words, the BMC 115 can record the output messages as well as the receiving time thereof when the output messages are received.

Accordingly, when the remote device 310 transmits a command including a specified time (may be a unit time or a time period) to the BMC 115, the BMC 115 can acquire the output messages of which the recorded receiving time matches with the specified time carried by the command mentioned above, such as the output messages of which the receiving time is within the specified time, or the output messages of which the receiving time is exact the specified time. In addition, when the buffer 117 is full, the output message with the earliest receiving time can be transmitted to the storage unit of the BMC 115 and the output message with the earliest receiving time is replaced by the newly-received output message. The remote device 310 can also read the output messages through the network from the storage units mentioned above. The storage unit mentioned above may for example be a hard disk, a storage device and so on.

Moreover, after the corresponding output messages are acquired, the BMC 115 can further record an acquiring time when the output messages are acquired. Then, when the buffer 117 is full, the BMC 115 can further delete the acquired output messages according to the recorded acquiring time. Thus, the buffer 117 can be emptied to continue to store the output messages from the serial port 113. Alternatively, when receiving a message deleting command from the remote device 310, the BMC 115 deletes the output messages marked with the acquiring time.

In addition, the remote device 310 may further transmit a turn-off command to the BMC 115, so that the collection of the output messages of the mainboard system 111 is stopped and the content of the buffer 117 is reset when the BMC 115 receives the turn-off command. For example, when the BMC 115 is connected with the remote device 310, the remote device 310 transmits the turn-off command to enable the BMC 115 to stop receiving the output messages and transfer the control power to the remote device 310. Moreover, the remote device 310 can also transmit an OEM command to the BMC 115 to adjust the capacity of the buffer 117.

In actual application, the message processing method mentioned above can be realized in a processing module of the BMC 115. The processing module for example is, but not limited to a microprocessor, an embedded chip or a firmware. In addition, the BMC 115 can further determine whether to store the received output messages into the buffer 117 according to whether the SOL function is enabled. For example, when the SOL function is enabled, the BMC 115 stops collecting the output messages from the serial port 113 temporarily. When the SOL function is turned off, the BMC 115 begins to collect the output messages from the serial port 113 again and store the output messages from the serial port 113 into the buffer 117.

To illustrate clearly, another embodiment is illustrated with the BMC 115 of FIG. 1 as an example hereinafter, but it is only one of the implementation aspects, and the present invention is not limited to this.

FIG. 4 is a block diagram of a processing module of a baseboard management controller according to an embodiment of the present invention. As shown in FIGS. 3 and 4, the BMC 115 includes a processing module 400. The processing module 400 includes a receiving module 401, a recording module 403, a connecting module 405, an acquiring module 407 and a deleting module 409. The modules mentioned above can be realized by a program code written in programming language or an independent chip, but the present invention is not limited to this.

In the BMC 115, the output messages are received by the receiving module 401 from the serial port 113 of the mainboard system 111. The output messages received by the receiving module 401 are stored into the buffer 117 by the recording module 403. Moreover, the receiving time when the output messages are received from the mainboard system 111 and the acquiring time when the output messages are acquired can also be recorded into the buffer 117 by the receiving module 403.

Furthermore, the BMC 115 is connected to the remote device 310 by the connecting module 405, so as to receive a command from the remote device 310. For example, when the SOL function is enabled, the BMC 115 is connected to the remote device 310 by the connecting module 405. The corresponding output message is acquired from the buffer 117 by the acquiring module 407 according to the command received by the connecting module 405. Then, the corresponding output message acquired by the acquiring module 407 is transmitted to the remote device 310 by the connecting module 405. For example, the output message of which the receiving time matches with the specified time is acquired from the buffer 117 by the acquiring module 407. Furthermore, when the buffer 117 is full, the acquired output messages can be deleted according to the recorded acquiring time by the deleting module 409. Alternatively the output messages marked with the acquiring time can be deleted by the deleting module 409 when a message deleting command is received.

In view of the above, in the embodiments above, a buffer is provided in the BMC. When the networking function (such as the SOL function) is turned off, the received output messages can be temporarily stored in the buffer of the BMC. When the networking function is enabled, the output messages outputted by the mainboard system in the past can be acquired from the buffer according to the command received from the remote device. Therefore, even when the remote device is not connected to the BMC, the output messages outputted by the mainboard system are also collected automatically by the BMC, and thus after the networking function is enabled, the output messages outputted by the mainboard system previously can be acquired at any time by the remote device.

Although the present invention has been disclosed with reference to the above embodiments, these embodiments are not intended to limit the present invention. It will be apparent to those of skilled in the art that various modifications and variations can be made without departing from the spirit and scope of the present invention. Therefore, the scope of the present invention shall be defined by the appended claims.

What is claimed is:

1. A message processing method for a server system, which is suitable for a baseboard management controller, wherein the server system comprises the baseboard management controller and a mainboard system having a serial port connected with the baseboard management controller, and the method comprises:
a preliminary step:
creating a buffer in the memory of the baseboard management controller;
executing steps:
receiving multiple output messages by the baseboard management controller from the serial port of the mainboard system;
performing a first mode by the baseboard management controller to store the output messages into the buffer;
performing a second mode by the baseboard management controller according to a switching command to stop storing the output messages into the buffer and enable a remote device to access the serial port through a network to exchange data with the mainboard system;
receiving a command from the remote device through the network and acquiring corresponding output messages from the buffer according to the command; and
transmitting the corresponding output messages to the remote device.

2. The message processing method of claim 1, wherein after the step of receiving the output messages from the serial port of the mainboard system, the message processing method further comprises:
recording a receiving time when the output messages are received from the mainboard system into the buffer.

3. The message processing method of claim 2, wherein the command comprises a specified time and the step of acquiring the corresponding output messages from the buffer according to the command further comprises:
acquiring the output messages of which the receiving time matches with the specified time from the buffer.

4. The message processing method of claim 2, further comprising:
transmitting the output message with the earliest receiving time to a storage unit of the baseboard management controller when the buffer is full, and replacing the output message with the earliest receiving time by a newly-received output message to enable the remote device to read the output messages from the storage unit through the network.

5. The message processing method of claim 1, wherein after the step of acquiring the corresponding output messages from the buffer according to the command, the message processing method further comprises:
recording an acquiring time when the output messages are acquired and deleting the output messages marked with the acquiring time when a message deleting command is received.

6. The message processing method of claim 1, further comprising:
stopping collecting the output messages of the mainboard system and resetting the content of the buffer when a turn-off command is received from the remote device.

7. The message processing method of claim 1, further comprising:
sending the switching command from the remote device.

8. A server system, comprising:
a mainboard system having a serial port; and
a baseboard management controller having a buffer and a network interface; wherein the baseboard management controller is coupled to the serial port to store multiple output messages received from the serial port into the buffer; and the baseboard management controller is connected to a remote device through the network interface, the output messages are stopped from being stored into the buffer according to a switching command, and the remote device accesses the serial port through the network interface to exchange data with the mainboard system; and when a command is received from the remote device, the corresponding output messages are acquired from the buffer and transmitted to the remote device according to the command.

9. The server system of claim 8, wherein the baseboard management controller records a receiving time when the output messages are received from the mainboard system into the buffer, and when the command comprising a specified time is received, the baseboard management controller outputs the output messages of which the receiving time matches with the specified time to the remote device.

10. The server system of claim 8, wherein the baseboard management controller records an acquiring time when the output messages are acquired and deletes the output messages marked with the acquired time when a message deleting command is received

11. The server system of claim 8, wherein when a turn-off command is received from the remote device, the baseboard management controller stops collecting the output messages of the mainboard system and resets the content of the buffer.
